(19) United States
(12) Patent Application Publication
(10) Pub. No.: US 2015/0035473 A1
(43) Pub. Date: Feb. 5, 2015

(54) INTELLIGENT CHARGING SYSTEM AND CHARGING ASSEMBLY

(71) Applicant: CHERVON INTELLECTUAL PROPERTY LIMITED, Road Town (VG)

(72) Inventors: Qiwei Zhou, Nanjing (CN); Tianshi Yuan, Nanjing (CN)

(73) Assignee: CHERVON INTELLECTUAL PROPERTY LIMITED

(21) Appl. No.: 14/446,743

(22) Filed: Jul. 30, 2014

(30) Foreign Application Priority Data
Aug. 2, 2013 (CN) 201310335974.0

(51) Int. Cl. H02J 7/00

(52) U.S. Cl. CPC H02J 7/0042; H02J 7/0052; H02J 2007/0096
USPC 320/103; 320/112

(57) ABSTRACT

An intelligent charging system includes a charging device, a battery pack, an electric tool powered by the battery pack, and a terminal device capable of communicating with the charging device and having a network communication function on its own. The charging system provides effective information chains between the integral parts, achieves remote operation or setting, improves utilization rate of the charging system, and facilitates the user to use an apparatus obtaining electrical energy from the charging system in a planned manner. The charging assembly helps the user to use the terminal device to control the charging procedure.

### RELATED APPLICATION INFORMATION

This application claims the benefit of CN 201310335974.0, filed Aug. 2, 2013, the disclosure of which is incorporated herein by reference in its entirety.

### FIELD OF THE DISCLOSURE

The subject disclosure generally relates to charging systems, and more particularly to an intelligent charging system and a charging assembly for charging battery packs intelligently.

### BACKGROUND OF THE DISCLOSURE

Electric tools using battery packs for supplying power are generally known. When a battery pack is lacking power, a user should charge it by using a charging device. With known battery pack systems, users cannot manage the charging process of the charging devices if the users are not in the vicinity of the charging devices.

### SUMMARY

Described hereinafter is an intelligent charging system and a charging assembly for charging battery packs intelligently.

More particularly, an exemplary intelligent charging system comprises a charging device which is capable of communicating with the other members of an intelligent charging system wirelessly and receiving electrical energy from a power grid, a battery pack for storing electrical energy from the charging device and supplying electrical energy to other members of the intelligent charging system, an electric tool which is powered by the battery pack, and a terminal device for communicating with the charging device and internet, wherein the charging device is capable of connecting to the terminal device.

Further, the charging device may comprise a first interface module for connecting with the battery pack, an electrical energy adjusting module for adjusting the electrical energy received from a power grid, a first communication module for communicating with the other members of the intelligent charging system, and a first control module for controlling the charging device intelligently.

Further, the electrical energy adjusting module may be electrically connected to the first interface module, and the first control module may be electrically connected to the first interface module, and the first interface module may be controlled by the first control module and be capable of sending a signal to the first control module.

Further, the first communication module may comprise a first wireless communication module for communicating with the other members of the intelligent charging system wirelessly.

Further, the battery pack may comprise a second interface module for connecting to the first interface module; a battery module for storing electrical energy; a second communication module for communicating with the charging device, the electric tool and the terminal device; and a second control module for controlling the battery pack.

Further, the second control module may be electrically connected to the second interface module, and the second interface module may be controlled by the second control module and be capable of sending a signal to the second control module.

Further, the first control module may comprise a connection control unit which is capable of recognizing the battery pack which is connected to the first interface module by the second interface module and controlling signal transmission with the second control module of the battery pack; a terminal control unit which is capable of recognizing the terminal device and controlling the signal transmission with the terminal device; a tool control unit which is capable of recognizing the electric tool and controlling the signal transmission with electric tool; and a main control unit which is capable of controlling the connection control unit, the terminal control unit and the tool control unit.

Further, the main control unit may be capable of performing bi-directional signal transmission with the connection control unit, the terminal control unit and the tool control unit.

Further, electric tool may comprise a third interface module for connecting to the second interface module; a third communication module for communicating with the charging device, the battery pack and the terminal device; and a third control module for controlling the electric tool.

Further, the third control module may be electrically connected to the third interface module, and the third interface module may be controlled by the third control module and be capable of sending a signal to the third control module.

Further, the third control module may comprise an battery pack control unit which is capable of controlling the battery pack and signal transmission with the battery pack; and a standby mode control unit which is capable of performing signal transmission with the charging device and controlling the electrical connection between the electric tool and battery pack.

Further, the electric tool further may comprise a built-in battery which is capable of storing the electrical energy which is from the battery pack so as to supply the electrical energy of the third control module when the battery pack being removed.

Further, wherein terminal device may comprise a terminal communication module for communicating with the first wireless communication module; a central processing unit for controlling the charging device, the battery pack and the electric tool; and a human-machine interaction interface for performing and controlling human-machine interaction.

Further, the charging device may be capable of communicating with the terminal device by Bluetooth or Wi-Fi.

Further, the charging assembly may comprise a charging device which is capable of communicating with the other members of the charging assembly wirelessly and receiving electrical energy from a power grid and a battery pack for storing electrical energy from the charging device and supplying electrical energy to an electric tool wherein the charging device comprises a first communication module for communicating with the other members of the intelligent charging system.

Further, the first communication module may comprise a first wireless communication module which is capable of communicating with other devices wirelessly.

Further, the charging device may comprise a first interface module for connecting with the battery pack; an electrical energy adjusting module for adjusting the electrical energy received from a power grid; and a first control module for controlling the charging device intelligently.

Further, the electrical energy adjusting module is electrically connected to the first interface module, and the first control module is electrically connected to the first interface module, and the first interface module is controlled by the first control module and is capable of sending a signal to the first control module.

Further, the battery pack may comprise a second interface module for connecting to the first interface module; a battery module for storing electrical energy; a second communication module for communicating with the charging device, the electric tool and the terminal device; and a second control module for controlling the battery pack, wherein the second control module is electrically connected to the second interface module, and the second interface module is controlled by the second control module and is capable of sending a signal to the second control module.

Further, the first control module may comprise a connection control unit which is capable of recognizing the battery pack which is connected to the first interface module by the second interface module and controlling signal transmission with the second control module of the battery pack; a terminal control unit which is capable of recognizing the terminal device and controlling the signal transmission with the terminal device; a tool control unit which is capable of recognizing the electric tool and controlling the signal transmission with electric tool; and a main control unit which is capable of controlling the connection control unit, the terminal control unit and the tool control unit, wherein the main control unit is capable of performing bi-directional signal transmission with the connection control unit, the terminal control unit and the tool control unit.

The present disclosure is advantageous in that the charging system of the present disclosure provides effective information chains between the integral parts so that the user, whenever and wherever, can effectively control the system information and achieve remote operation or setting, whereby the utilization rate of the charging system is improved, and the user can more conveniently use an apparatus obtaining electrical energy from the charging system in a planned manner.

### BRIEF DESCRIPTION OF THE DRAWINGS

FIG. 1 is a block diagram of an exemplary charging system constructed according to the present disclosure;

FIG. 2 is a block diagram of an exemplary charging device of the system shown in FIG. 1.

### DETAILED DESCRIPTION

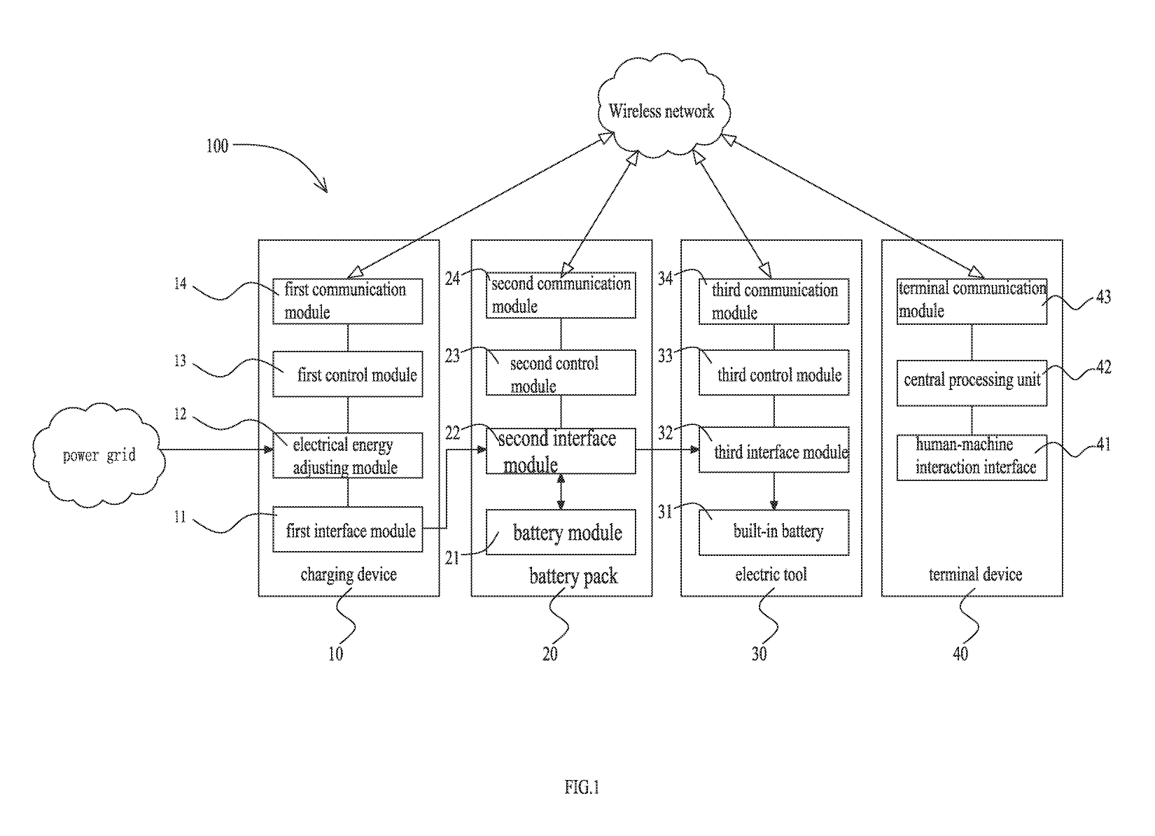

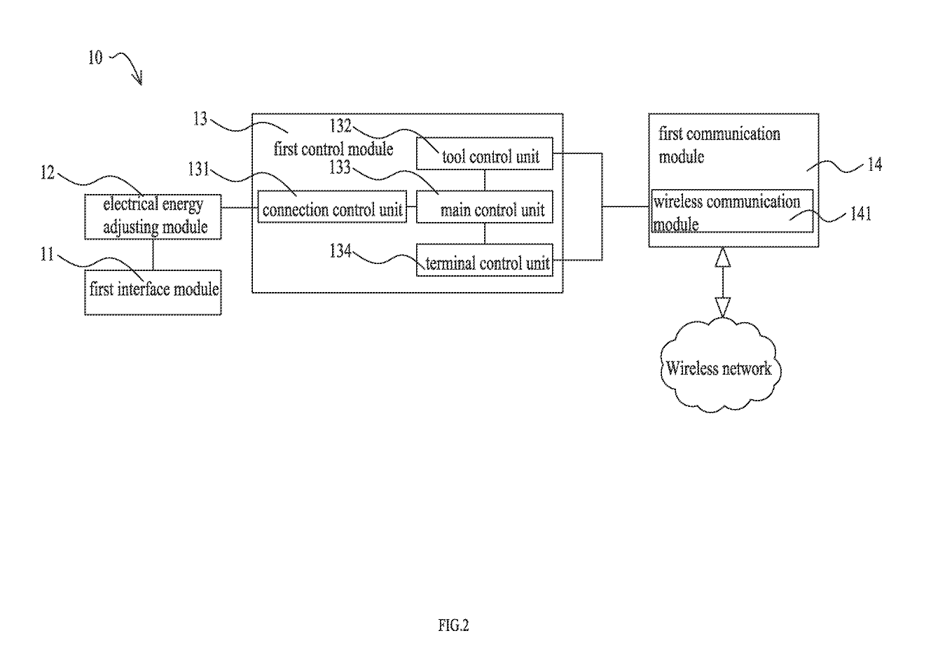

FIG. 1 and FIG. 2 illustrate a charging system 100. The charging system 100 includes a charging device 10. The charging device 10 is used to receive electrical energy from a power grid for charging battery pack 20, and the charging device 10 communicates with the other members of intelligent charging system 100 wirelessly.

The charging device 10 includes a first interface module 11 for connecting with the battery pack 20, an electrical energy adjusting module 12 for adjusting the electrical energy received from a power grid and a first control module 13 for controlling the charging device intelligently.

The charging device 10 further includes a first communication module 14 for communicating with the other members of intelligent charging system 100 by wire or wirelessly.

The electrical energy adjusting module 12 is electrically connected to the first interface module, and the first control module 13 is electrically connected to the first interface module 11, and the first interface module 11 is controlled by the first control module 13 and is capable of sending a signal to the first control module 13.

The first interface module 11 is used to connect with devices needing electrical energy such as the battery pack 20. The electrical energy adjusting module 12 is capable of adjusting the electrical energy and supplying the electrical energy to the first interface module 11 and the first control module 13.

The electrical energy adjusting module 12 is capable of performing AC-DC and high voltage-low voltage electrical energy adjustment.

The first control module 13 can recognize the battery pack 20 according to an electric signal from the first interface module 11 when the first interface module 11 is connected with the battery pack 20.

According to the result of the recognition, the first control module 13 controls the electrical energy adjusting module 12 so as to adjust the electrical energy which is output at the first interface module 11.

The user may communicate with the charging device 10 via use of a personal, intelligent communication terminal such as a computer, an intelligent mobile phone or a flat panel computer. As such, the user may control the charging device 10 through a human-machine interface provided by the terminal device 40. When the charging device 10 is charging the battery pack, the user can monitor and control the charging device 10.

When the charging device, for some reason (such as for reasons of security), is placed in an environment which is not suitable for the user to stay long whereas the user may stay at a fixed location stably when the charging device 10 works, even though there is not a wireless network, the terminal device 40 may be a fixed equipment which is, together with the charging device 10, accessed to the same wired network, for example, a desktop computer. The wired network may be a general local area network completely used to achieve data transmission, or a complex network built through power carrier technology.

However, in order to provide the most convenient operation experience for the user, popularize wireless network and reduce costs, the present disclosure is more inclined to select a mobile equipment, or a mobile equipment along with a fixed equipment, as a device for communicating with the charging device 10 in the present disclosure, and its fundamental purpose is to avoid the space from affecting the user's use of the charging device.

As a preferred solution, the first communication module 14 includes a first wireless communication module 141 communicating with the other members of an intelligent charging system 100 wirelessly, at least with the battery pack 20.

The terminal device 40 includes a human-machine interaction interface 41 for performing and controlling human-machine interaction; a central processing unit 42 for controlling the charging device 10, the battery pack 20 and the electric tool by exchanging and processing data; and a terminal communication module 43 for communicating with the first wireless communication module 141.

The central processing unit 42 also controls the human-machine interaction interface 41 and the terminal communication module 43.

As such, a bi-directional signal transmission between the whole intelligent charging system 100 and the user can be achieved through its own human-machine interaction interface 41 on the basis of achievement of communications.

Software in the terminal device 40 for controlling other members in the intelligent charging system 100 may be obtained by downloading in the following manners: the first manner is that the terminal device 40 accesses a designated website to download and obtain a right to control by validating an initial password or setting a password; and the second manner is that when the terminal device 40 successfully searches for the charging device 10, the battery pack 20 and the electric tool 30 and sends a matching request for wireless communication, the software is transmitted to the terminal device 40 if a matching password can be entered correctly, and a right to set a password will be granted to the user. If the terminal device 40 has a corresponding hardware, biological recognition such as fingerprint or iris identification may be used as a secret key for validation.

Preferably, the charging device 10 is capable of communicating with the terminal device 40 by Bluetooth or Wi-Fi.

Additionally, the recognition of the charging device 10 for the battery pack 20 may be achieved by recognizing an electronic tag through wireless communication. Each battery pack 20 has an electrical energy tag, and the charging device 10 can recognize the battery pack 20 by recognizing the electronic tag of the battery pack 20.

The battery pack 20 and the electric tool 30 in the intelligent charging system 100 also have wireless communication functionality.

Specifically, the battery pack 20 includes a battery module 21 for storing electrical energy, a second interface module 22 for connecting to the first interface module 11, a second control module for controlling the battery pack 23, and a second communication module 24 for communicating with the charging device 10, the electric tool 30 and the terminal device 40.

The second control module 23 is electrically connected to the second interface module 22, and the second interface module 22 is controlled by the second control module 23 and is capable of sending a signal to the second control module 23.

The electric tool 30 includes a third interface module 32 for connecting to the second interface module 22 of battery pack 20; a third control module 33 for controlling the electric tool 30; and a third communication module 34 for communicating with the charging device 10, the battery pack 20 and the terminal device 40.

The third control module 34 is electrically connected to the third interface module, and the third interface module is controlled by the third control module 34 and is capable of sending a signal to the third control module 34.

Preferably, the first control module 13 includes: a connection control unit 131 capable of recognizing the battery pack 20 which is connected to the first interface module 11 and controlling signal transmission with the second control module 23 of the battery pack 20; a tool control unit 132 which is capable of recognizing the electric tool 30 and controlling the signal transmission with electric tool 30; a main control unit 133 for controlling the connection control unit 131, the tool control unit 132, and the terminal control unit 134; and a terminal control unit 134 which is capable of recognizing the terminal device 40 and controlling the signal transmission with the terminal device 40.

The connection control unit 131, the terminal control unit 134 and the tool control unit 132 each performs bi-directional signal transmission with the main control unit 133.

The third control module 34 includes an battery pack control unit which is capable of controlling the battery pack 20 and signal transmission with the battery pack 20; and a standby mode control unit which is capable of performing signal transmission with the charging device 10 and controlling the electrical connection between the electric tool 30 and battery pack 40.

When the battery pack 20 is connecting to the electric tool 30, the third control module 34 of the electric tool 30 can recognize which battery pack 20 is being used by itself and the electrical quantity, which are then uploaded to the terminal device through the third communication module, or not uploaded. If the user is using the electric tool 30, the battery pack and the electrical quantity thereof may be directly displayed on an operation interface of the electric tool 30. When the electrical energy of the battery pack 20 falls to a predetermined, lower limit, the user will be notified through the electric tool 30 or the terminal device 40. In order to enable the electric tool 30 to still have sufficient electrical energy position to control the circuit after the battery pack 20 is drawn out, as a preferred solution, the electric tool 30 further includes a built-in battery 31 capable of storing electrical energy of the battery pack 20 so as to maintain the electrical energy of the third control module 34 after the battery pack 20 is removed. The user sends the battery pack 20 to the charging device 10 for charging, whereupon both the electric tool 30 and the terminal device 40 can display the battery pack 20 is being charged on which charging device 10 and display a predicted charging duration. The display on the electric tool 30 is advantageous in that the user actually using the tool can master the charging situation from time to time in order to arrange his own work because the user of the terminal device and the user of the electric tool 30 are usually not the same person. In addition, the charging device 10 can also prompt the user that there is a battery pack 20 not charged yet, particularly when the charging device 10 is idle, thus the utilization rate of the charging device 10 by the user may be improved.

It should be noted that there may be a plurality of charging devices 10, a plurality of battery packs 20, a plurality of electric tools 30 and a plurality of terminal devices 40 in the present disclosure.

The present disclosure further provides a charging assembly, which mainly includes the charging device 10 and battery pack 20 as stated above.

Specifically, they may serve as a charger and a battery pack applied to the electric tool. When the charging device 10 is used as the charger, it has a function of performing wireless communication with the outside world, and the user may control the charging situation in real time through the mobile terminal device 40.

The above illustrates and describes the basic principles, main features and advantages of the present disclosure. Those skilled in the art should appreciate that the embodiments by no means limit the present disclosure, and all technical solutions obtained by employing equivalent substitutes or equivalent variations fall within the protection scope of the present disclosure.

What is claimed is:

1. An intelligent charging system comprising :
a charging device adapted to communicate with other members of an intelligent charging system wirelessly and to receive electrical energy from a power grid;
a battery pack for storing electrical energy from the charging device and supplying electrical energy to other members of the intelligent charging system;
an electric tool which is powered by the battery pack; and
a terminal device for communicating with the charging device and internet;
wherein the charging device is adapted to connect to the terminal device.

2. The intelligent charging system according to claim 1, wherein the charging device comprises:
a first interface module for connecting with the battery pack;
an electrical energy adjusting module for adjusting the electrical energy received from the power grid;
a first communication module for communicating with the other members of the intelligent charging system; and
a first control module for controlling the charging device intelligently.

3. The intelligent charging system according to claim 2, wherein the electrical energy adjusting module is electrically connected to the first interface module, the first control module is electrically connected to the first interface module, and the first interface module is controlled by the first control module and is adapted to send a signal to the first control module.

4. The intelligent charging system according to claim 3, wherein the first communication module comprises a first wireless communication module for communicating with the other members of intelligent charging system wirelessly.

5. The intelligent charging system according to claim 4, wherein the battery pack comprises:
a second interface module for connecting to the first interface module;
a battery module for storing electrical energy;
a second communication module for communicating with the charging device, the electric tool and the terminal device; and
a second control module for controlling the battery pack.

6. The intelligent charging system according to claim 5, wherein the second control module is electrically connected to the second interface module and the second interface module is controlled by the second control module and is adapted to send a signal to the second control module.

7. The intelligent charging system according to claim 6, wherein the first control module comprises:
a connection control unit which is adapted to recognize the battery pack which is connected to the first interface module by the second interface module and to control signal transmission with the second control module of the battery pack;
a terminal control unit which is adapted to recognize the terminal device and to control the signal transmission with the terminal device;
a tool control unit which is adapted to recognize the electric tool and to control the signal transmission with electric tool; and
a main control unit which is adapted to control the connection control unit, the terminal control unit and the tool control unit.

8. The intelligent charging system according to claim 7, wherein the main control unit is adapted to perform bi-directional signal transmission with the connection control unit, the terminal control unit and the tool control unit.

9. The intelligent charging system according to claim 8, wherein electric tool comprises:
a third interface module for connecting to the second interface module;
a third communication module for communicating with the charging device, the battery pack and the terminal device; and
a third control module for controlling the electric tool.

10. The intelligent charging system according to claim 9, wherein the third control module is electrically connected to the third interface module and the third interface module is controlled by the third control module and is adapted to send a signal to the third control module.

11. The intelligent charging system according to claim 10, wherein the third control module further comprises:
a battery pack control unit which is adapted to control the battery pack and signal transmission with the battery pack; and
a standby mode control unit which is adapted to perform signal transmission with the charging device and to control the electrical connection between the electric tool and battery pack.

12. The intelligent charging system according to claim 11, wherein the electric tool further comprises a built-in battery which is adapted to store electrical energy which is from the battery pack so as to supply the electrical energy of the third control module when the battery pack is removed.

13. The intelligent charging system according to claim 12, wherein terminal device comprises:
a terminal communication module for communicating with the first wireless communication module;
a central processing unit for controlling the charging device, the battery pack and the electric tool; and
a human-machine interaction interface for performing and controlling human-machine interaction.

14. The intelligent charging system according to claim 1, wherein the charging device is adapted to communicate with the terminal device by Bluetooth or Wi-Fi.

15. A charging assembly, comprising:
a charging device adapted to communicate with other members of a charging assembly wirelessly and to receive electrical energy from a power grid; and
a battery pack for storing electrical energy from the charging device and supplying electrical energy to an electric tool;
wherein the charging device comprises a first communication module for communicating with other members of an intelligent charging system.

16. The charging assembly according to claim 15, wherein the first communication module comprises a first wireless communication module which is adapted to communicate with the other devices of the intelligent charging system wirelessly.

17. The charging assembly according to claim 16, wherein charging device further comprises:
a first interface module for connecting with the battery pack;
an electrical energy adjusting module for adjusting the electrical energy received from a power grid; and
a first control module for controlling the charging device intelligently.

18. The charging assembly according to claim 17, wherein the electrical energy adjusting module is electrically connected to the first interface module, the first control module is electrically connected to the first interface module, and the first interface module is controlled by the first control module and is adapted to send a signal to the first control module.

19. The charging assembly according to claim 18, wherein the battery pack comprises:
a second interface module for connecting to the first interface module;
a battery module for storing electrical energy;
a second communication module for communicating with the charging device, the electric tool and the terminal device; and
a second control module for controlling the battery pack;
wherein the second control module is electrically connected to the second interface module and the second interface module is controlled by the second control module and is adapted to send a signal to the second control module.

20. The charging assembly according to claim 19, wherein the first control module comprises:
a connection control unit adapted to recognize the battery pack which is connected to the first interface module by the second interface module and to control signal transmission with the second control module of the battery pack;
a terminal control unit adapted to recognize the terminal device and to control the signal transmission with the terminal device;
a tool control unit adapted to recognize the electric tool and to control the signal transmission with electric tool; and
a main control unit adapted to control the connection control unit, the terminal control unit and the tool control unit;
wherein the main control unit is adapted to perform bi-directional signal transmission with the connection control unit, the terminal control unit and the tool control unit.
